(19) United States
(12) Patent Application Publication
(10) Pub. No.: US 2003/0227436 A1
(43) Pub. Date: Dec. 11, 2003

(54) Electrophoretic display apparatus

(75) Inventor: Tsutomu Ikeda, Tokyo (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/453,768

(22) Filed: Jun. 4, 2003

(30) Foreign Application Priority Data
Jun. 10, 2002 (JP) 2002-168185

(51) Int. Cl. G09G 3/34

(52) U.S. Cl. 345/107

(57) ABSTRACT

The invention provides an electrophoretic display apparatus including a display substrate and a rear substrate positioned with a predetermined gap therebetween, partition members positioned between the substrates to partition a space between the substrates into pixels, a liquid and plural charged particles positioned in each pixel, and a first electrode and a second electrode provided in each pixel, and adapted to provide a display by applying a voltage between the electrodes thereby moving the charged particles, wherein a transparent film thinner than the display substrate is positioned between the display substrate and the partition member, and a transparent member is positioned between the transparent film and the display substrate. The invention prevents deterioration in image quality, resulting from migration of the charged particles to other pixels.

### BACKGROUND OF THE INVENTION

1. Field of the Invention

The present invention relates to an electrophoretic display apparatus which performs a display by moving charged particles in a liquid.

2. Related Background Art

In the field of an electrophoretic display apparatus which performs a display by electrophoretically moving charged particles in an insulating liquid, various types have been proposed. In the following there will be given an explanation on such electrophoretic display apparatus.

With the progress of information processing equipment, a thin display apparatus of a low electric power consumption is being desired, and research and development are being actively made for meeting such needs. Particularly liquid crystal display apparatuses are actively developed and commercialized as a display apparatus capable of meeting such needs. However, the current liquid crystal display apparatus is still associated with a drawback that displayed characters are often not easily recognizable depending on a viewing angle to the display screen or by a reflected light, and a drawback of a serious burden to the human eyes because of a flickering of the light source or a low display luminance, and such drawbacks have not been sufficiently resolved. Therefore, a reflective display apparatus is anticipated in view of achieving a low electric power consumption and alleviating the burden to the human eyes.

As one of such reflective display apparatus, an electrophoretic display apparatus has been proposed by Harold D. Lees et al. (U.S. Pat. No. 3,612,758).

FIG. 4A shows a configuration of such electrophoretic display apparatus, which is provided with a pair of substrates 41, 42 positioned at a predetermined gap (hereinafter suitably called “an upper substrate 41” and “a lower substrate 42”), an insulating liquid 43 filled between the substrates 41, 42, a plurality of colored and charged electrophoretic particles 44 dispersed in the insulating liquid 43, and display electrodes 45, 46 positioned in each pixel so as to respectively lie on the substrates 41, 42. Between pixels, there is provided a partition 47 to prevent a movement of the colored and charged electrophoretic particles 44 to other pixels, thereby maintaining a uniform display. FIGS. 4A and 4B are cross-sectional view each showing a single pixel, and an actual electrophoretic display apparatus is constituted by arranging a plurality of such pixels.

In such apparatus, the colored and charged electrophoretic particles 44, being charged positively or negatively, are attracted to either of the display electrodes 45, 46 depending on a polarity of a voltage applied thereto. On the other hand, the insulating liquid 43 and the colored and charged electrophoretic particles 44 have respectively different colors. As a result, in case the colored and charged electrophoretic particles 44 are attracted on the display electrode 45 at a side of an observer (FIG. 4B), the color of such particles 44 is observed, while, in case the colored and charged electrophoretic particles 44 are attracted to the display electrode 46 of the other side (FIG. 4A), the color of the insulating liquid 43 is observed. It is therefore possible to display various images by controlling the polarity of the applied voltage for each pixel.

In this manner, the electrophoretic display apparatus performs a display by a reflected light from a pigment or a dye. It is therefore rendered possible to obtain an image quality close to a paper, rather than a display. For this reason, the electrophoretic display apparatus is a promising candidate for so-called electronic paper, which has a display quality similar to that of paper and a re-writable function of the display.

In manufacturing an electrophoretic display apparatus as described above, there has been employed a method of forming partitions 47 on a substrate (for example the lower substrate 42), then pouring (dropping) the insulating liquid 43 and the charged electrophoretic particles 44, and adhering the other substrate (for example the upper substrate 41). Also highly rigid glass substrates are employed for the substrates 41, 42.

However, unless the partitions 47 have a uniform height, a gap is generated between the partition 47 and the upper substrate 41 after the adhesion thereof, whereby the movement of the colored and charged electrophoretic particles 44 to other pixels cannot be prevented, thereby resulting in a deterioration of the display.

For avoiding such drawback, there is proposed a method of employing a flexible substrate as the substrate to be applied later, thereby preventing formation of a gap between the partitions 47 and the upper substrate 41 (Japanese Patent Publication No. 2733679). Also since such substrate of a relatively small thickness for achieving flexibility is susceptible to moisture penetration or an external impact, Japanese Patent Publication No. 3002316 proposes to adhere a metal plate to such substrate.

However, the electronic paper is required to have a flexibility, but it is difficult to obtain a sufficient flexibility by merely preparing such conventional configuration on flexible substrates, because of following reason. When the two substrates are bent, there is generated a difference in the circumferential length between the substrates whereby a compression stress is applied to the partitions in a central part of the substrates while a very strong shearing stress is applied to the partitions in a peripheral part of the substrates. These stresses are concentrated in the partitions and at the adhering face between the partitions and the substrate, whereby a breakage is generated in the partitions when the substrates are bent strongly. Such displacement of the substrates or breakage cause displacement of the charged electrophoretic particles through the partitions.

### SUMMARY OF THE INVENTION

An object of the present invention is to provide an electrophoretic display apparatus capable of avoiding these drawbacks.

In consideration of the foregoing, the present invention provides an electrophoretic display apparatus comprising a display substrate and a rear substrate positioned with a predetermined gap between the substrate, partition members positioned between the substrate to partition a region between the substrates into pixels, a liquid and plural charged particles positioned in each pixel, and a first electrode and a second electrode provided in each pixel, and moving the charged particles by being applied a voltage between the electrodes to carry out a displaying, wherein a transparent film thinner than the display substrate is positioned between the display substrate and the partition member and a transparent member is positioned between the transparent film and the display substrate.

### BRIEF DESCRIPTION OF THE DRAWINGS

FIG. 1 is a cross-sectional view showing a configuration of an electrophoretic display apparatus of the present invention;

FIGS. 2A, 2B and 2C are schematic views showing an example of a producing method for the electrophoretic display apparatus of the present invention;

FIGS. 3A, 3B and 3C are schematic views showing another example of a producing method for the electrophoretic display apparatus of the present invention; and

FIGS. 4A and 4B are cross-sectional views showing a configuration of a conventional electrophoretic display apparatus.

### DESCRIPTION OF THE PREFERRED EMBODIMENTS

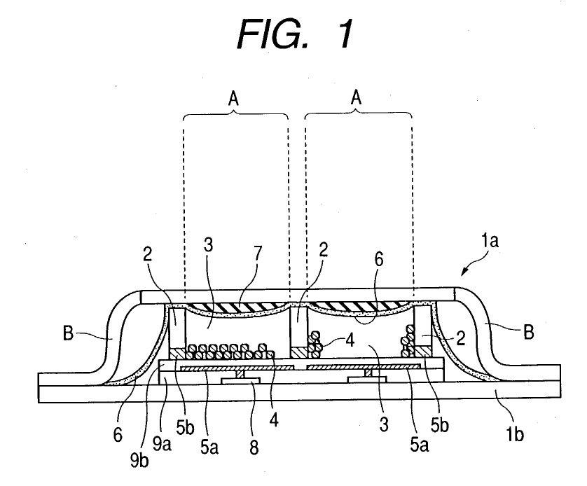

In the following, an embodiment of the present invention will be explained with reference to FIG. 1.

As shown in FIG. 1, the electrophoretic display apparatus of the present embodiment is provided with a display substrate 1a and a rear substrate 1b positioned with a predetermined gap therebetween, partition members 2 positioned between the substrates 1a, 1b and partitioning a region between the substrates into pixels A, a liquid 3, plural charged particles 4, a first electrode 5a and a second electrode 5b provided in each pixel A, and performs a display by applying a voltage between the electrodes 5a and 5b thereby displacing the charged particles 4.

For example, in case the second electrode 5b is positioned under the partition members 2 and the first electrode 5a is positioned along the rear substrate 1b as shown in FIG. 1, and in case the surface of the first electrode 5a is made white while the charged particles 4 are made black, the surface of the first electrode 5a is made observable to provide a white display when the charged particles 4 are attracted to the second electrode 5b (as shown in a right-hand side in FIG. 1), while the particles are observed to provide a black display when the charged particles 4 are attracted to the first electrode 5a (as shown in a left-hand side in FIG. 1). It is also possible to use other colors than black and white, and, in case the charged particles 4 are made black while the surface of the first electrode 5a is made red, green and blue, there can be obtained a color display by utilizing three pixels as a set. The surface of the first electrode 5a can be colored by:

coloring the electrode itself;

providing a colored layer separate from the electrode; or

utilizing an insulating layer formed so as to cover the electrode (for example utilizing the color of the insulating layer itself or by mixing a colored material into the insulating layer).

In the present embodiment, between the display substrate 1a and the partition members 2, there is provided a transparent film 6 thinner than the display substrate 1a, and a transparent member 7 is provided in each pixel between the transparent film 6 and the display substrate 1a.

The transparent member 7 is formed by a liquid or a solid, having a convex shape (namely a central portion protruding toward the liquid 3 or the rear substrate 1b in comparison with a peripheral portion). The transparent member 7 can be formed by a deformable material, such as isoparaffin, silicone oil, xylene, anisole or a UV-curing acrylic resin, or silicone rubber. The transparent member 7 preferably has a higher refractive index than in the liquid 3.

More specifically, the transparent member 7 and the liquid 3 preferably have a following relationship in the refractive index:

refractive index of transparent member 7>refractive index of liquid 3, and more preferably:

refractive index of transparent member 7>refractive index of transparent film 6>refractive index of liquid 3.

Since the transparent member 7 has a convex shape as explained in the foregoing, the above-mentioned relationship of the magnitude of the refractive indexes allows to concentrate the incident light into the central part. The concentration of the incident light into the central part provides an effect of rendering less visible the black particles moved to the peripheral part at the white display state, thereby improving the contrast of the display.

The display substrate 1a and the transparent film 6, mentioned above, are preferably adhered in an end portion thereof to the rear substrate 1b.

In case the electrophoretic display apparatus of the above-described configuration is bent, a stress resulting from the difference in the circumferential length between the display substrate 1a and the rear substrate 1b is principally absorbed by a slippage between the display substrate 1a and the transparent film 6 and by a soft end portion of the display substrate 1a. Also a stress resulting from a difference in the circumferential length of the transparent film 6 and the rear substrate 1b is absorbed by an elongation or a contraction of the transparent film.

The transparent film 6 need not be adhered to the partition members 2, but a peripheral portion of the transparent film needs to be adhered to the rear substrate 1b.

Also the aforementioned partition members 2 are provided for preventing the movement of the charged particles 4 to other pixels, but may also serve as spacers for defining the gap of the substrates. The partition members 2 may be formed by any material that can be patterned. For example there may be employed an acrylic resin or an epoxy rein having photosensitivity.

Also to each first electrode 5a, there may be connected a switching element 8 for active matrix drive.

For the rear substrate 1b, there can be employed a rigid substrate for example of a plastic film such as polyethersulfone (PES), polyethylene terephthalate (PET) or polycarbonate (PC), glass or quartz. Also for such substrate, there may be employed polyimide (PI), a colored metal substrate such as of stainless steel, or an opaque substrate. For the display substrate 1a, a transparent one may be employed among these materials. Also both substrates 1a, 1b may be formed with flexible materials.

The display substrate 1a is preferably made flexible in a peripheral portion (a portion indicated by B, excluding an image display portion). Such portion B is preferably adhered to the rear substrate 1b.

The transparent film 6 is preferably formed by a transparent and flexible plastic material. There can be advantageously employed polycarbonate resin or polystyrene resin, but a transparent resinous film such as of PET, polypropylene or polyethylene can also be employed. A thickness of the transparent film 6 is preferably smaller than a width of a pixel, namely a dimension A shown in FIG. 1, also preferably smaller than a height of the partition member 2, and more preferably equal to or less than a width of the partition member 2.

The electrodes 5a, 5b may be formed by any conductive material that can be patterned. For example there can be employed a metal such as chromium (Cr), aluminum (Al) or copper (Cu), carbon, silver paste or an organic conductive film. In case the first electrode 5a is utilized also as a light reflecting layer, there may be employed a material of a high light reflectance such as silver (Ag) or Al. Also the first electrode 5a can be made white, either by forming surface irregularities on the electrode surface itself so as to cause a random reflection of the light, or by forming a light scattering layer on the electrode.

The liquid 3 is preferably constituted by a transparent non-polar solvent such as isoparaffin, silicone oil, xylene or toluene.

The charged particles 4 are preferably formed by a material which is colored and shows a satisfactory positive or negative charging property in the aforementioned liquid. For example, there can be employed an inorganic pigment, an organic pigment, carbon black or a resin containing such materials. The particles are usable generally in a particle size of 0.01 to 50 μm, preferably 0.1 to 10 μm.

In the aforementioned liquid or in the charged particles, there is preferably added a charge controlling agent for controlling and stabilizing a charge on the charged particles. Examples of such charge controlling agent include succinimide, a metal complex of a monoazo dye, salicylic acid, an organic quaternary ammonium salt, or a nigrosin compound.

In the liquid, there may be added a dispersant for preventing coagulation of the charged particles and maintaining a dispersed state thereof. Examples of such dispersant include a polyvalent metal salt of phosphoric acid such as calcium phosphate or magnesium phosphate, a carbonate salt such as calcium carbonate, other inorganic salts, an inorganic oxide and an organic polymer.

In the following there will be explained the effect of the present invention.

In the present embodiment, in case the substrates are bent, a stress resulting from the difference in the circumferential length between the display substrate 1a and the rear substrate 1b is principally absorbed by a slippage between the display substrate 1a and the transparent film 6, and by a soft end portion B of the display substrate 1a. Also a stress resulting from a difference in the circumferential length of the transparent film 6 and the rear substrate 1b is absorbed by an elongation or a contraction of the transparent film. Therefore a stress on the partition member 2 in the shearing or compressing direction is made very small, and the substrates can be bent easily.

Also in case the transparent member 7 is constituted by a liquid, there can be realized a very smooth slippage between the display substrate 1a and the transparent film 6.

As the transparent film 6 is very thin and in close contact with the partition members 2, it is not separated therefrom when the substrates are bent, even though it is not adhered, whereby the charged particles 4 can be securely retained within the partition members.

Also since each pixel is shielded by a three-layered structure constituted by the display substrate 1a, the transparent film 6 and the transparent member 7, it is possible to prevent penetration of gas etc. from the exterior into each pixel.

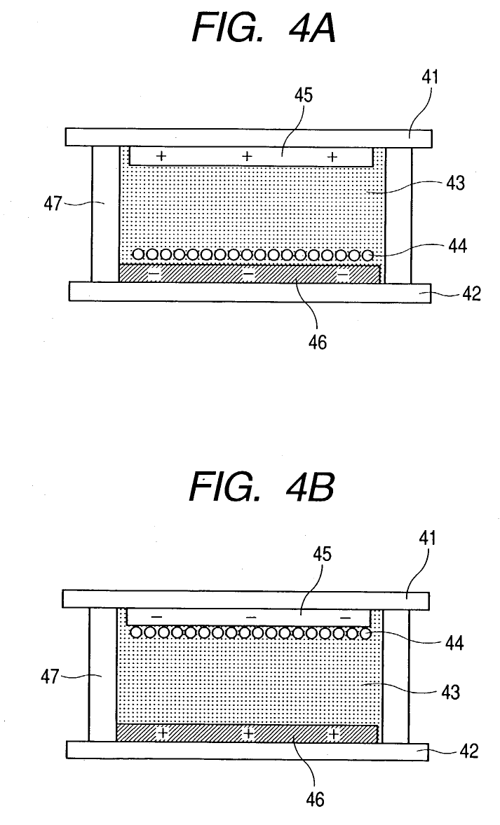

While the above embodiment illustrates a case wherein liquid 3 is transparent and the charged particles move on the rear substrate, it is a matter of course that the constitution of the present invention that a transparent film thinner than the display substrate is positioned between the display substrate and the partition member, and a transparent member is positioned between the transparent film and the display substrate can be applied to a conventional display apparatus shown in FIG. 4.

However, in the “electrophoretic display apparatus wherein the first electrode is arranged along the rear substrate, and the second electrode is arranged under the partition member” as shown in FIG. 1, by selecting the refractive index of the transparent member 7 larger than that of the liquid 3, there can be formed a self-aligned lens in each pixel, whereby the incident light can be concentrated in a central part of the pixel, thereby increasing the contrast.

### EXAMPLES

In the following, the present invention will be further clarified by examples thereof.

### Example 1

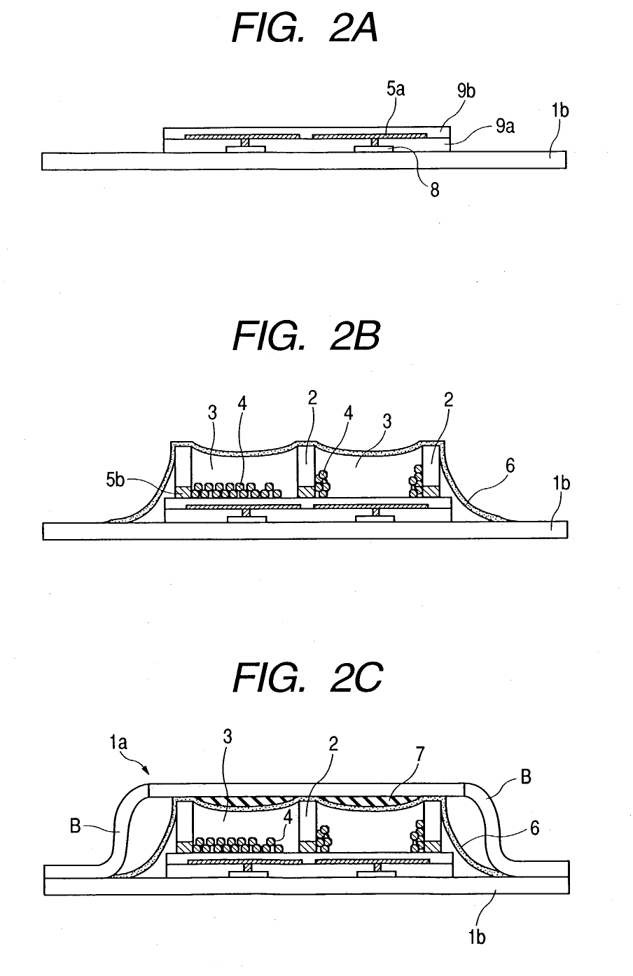

In this example, an electrophoretic display apparatus shown in FIG. 1 was prepared by a method shown in FIGS. 2A to 2C, as will be explained detailedly in the following. A stainless steel substrate of a thickness of 0.1 mm was employed as the rear substrate 1b. Each pixel A had a size of 240×80 μm, and there were formed 200×600 pixels. On the surface of the rear substrate 1b, a switching element 8 was formed in each pixel. Insulating layers 9a, 9b were provided so as to cover the switching element 8, and a first electrode 5a was positioned between the insulating layers 9a, 9b in each pixel. Each switching element 8 and each electrode 5a were electrically connected by a through-hole. The first electrode 5a was formed with aluminum of a high optical reflectance, in order to serve also as a light reflecting-scattering layer. The insulating layer 9a was formed with an acrylic resin. The insulating layer 9b was formed with an acrylic resin containing titanium oxide particles, thereby forming a light-scattering insulating layer (FIG. 2A).

A second electrode 5b was formed on the surface of the insulating layer 9b, in a position corresponding to a gap between the adjacent pixels, and the second electrodes for all the pixels were electrically so connected that they could be maintained at a same potential. Also partition walls 2 were formed with a width of 8 μm and a height of 20 μm. In each pixel, there were provided, as the insulating liquid 3, isoparaffin (trade name: Isopar, manufactured by Exxon) containing succinimide (trade name: OLOA1200, manufactured by Chevron Inc.) as the charge controlling agent, and, as the charged electrophoretic particles 4, a polystyrene-polymethyl methacrylate copolymer resin containing carbon black of a particle size of about 1 to 2 μm.

Then, on the partition walls 2, a polycarbonate film of a thickness of 5 μm was positioned as the transparent film 6 (cf. FIG. 2B). The transparent film 6 and the partition walls 2 were adhered, and a peripheral portion of the transparent film 6 was also adhered to the rear substrate 1b (FIG. 2B).

Then, after a transparent liquid was positioned as the transparent member 7 on the transparent film, there was positioned a display substrate 1a constituted by PET in a central part and by polyethylene in a peripheral part B. After the display substrate 1a and the transparent film 6 on the partition walls 2 were sufficiently contacted to eliminate bubbles and an excessive transparent liquid, the polyethylene in the peripheral part was thermally adhered to the rear substrate 1b (FIG. 2C). The obtained display apparatus was subjected to an electrical wiring operation to enable a displaying.

In the display apparatus thus prepared, the substrates could be easily bent forward or backward. No migration of the charged electrophoretic particles 4 occurred through the partition walls by such bending. Also the drive status of the display apparatus was not at all affected when it was operated for a prolonged period under a high humidity condition (90%), and no intrusion of bubbles into the display pixels occurred.

### Example 2

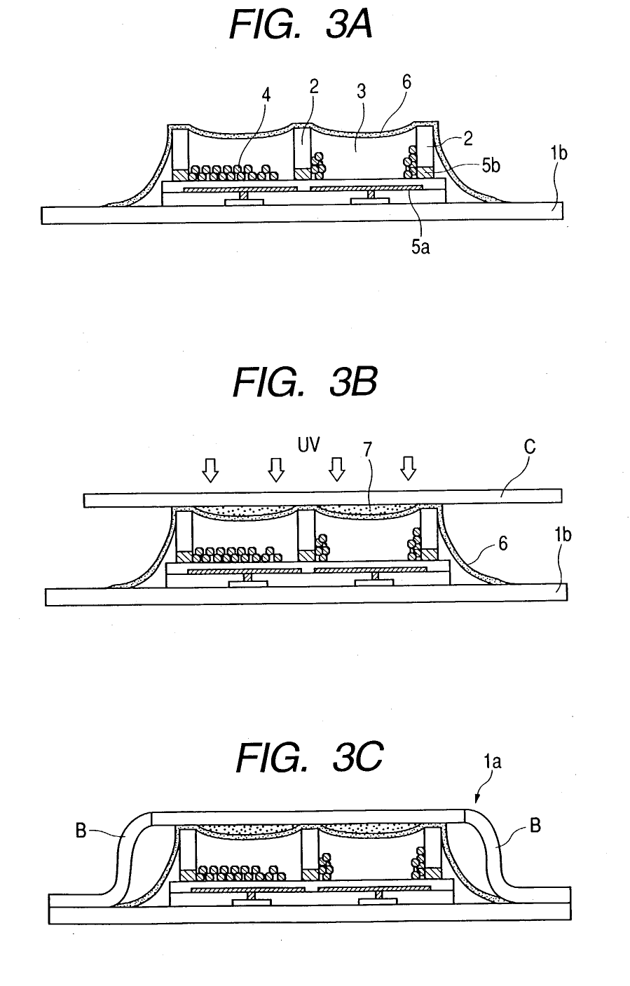

In this example, an electrophoretic display apparatus shown in FIG. 1 was prepared by a method shown in FIGS. 3A to 3C. Principal differences from the example 1 are:

material of the transparent member 7; and

transparent substrate (C) is employed in molding the transparent member 7.

Details will be explained in the following.

The rear substrate 1b was of a material same as in the example 1. However, a dimension of the partition walls 2 was different from that of the example 1 and had width of 5 μm and a height of 15 μm. Also each pixel A had a size of 200×65 μm, and there were formed 200×600 pixels. On the surface of the rear substrate 1b, as in the example 1, there were formed switching elements 8, insulating layers 9a, 9b and first electrodes 5a, and each switching element 8 and each electrode 5a were electrically connected by a through-hole.

Also as in the example 1, second electrodes 5b and partition walls 2 were formed in positions corresponding to gaps between the pixels on the surface of the insulating layer 9b, and an insulating liquid 3 and charged electrophoretic particles 4 were placed in each pixel. The second electrodes for all the pixels were electrically so connected that they could be maintained at a same potential.

Then, as in the example 1, a transparent film 6 was positioned on the partition walls 2, and was composed of a polypropylene film of a thickness of 2.5 μm and a refractive index of 1.45. The transparent film 6 and the partition walls 2 were maintained in sufficient contact, and a peripheral portion of the transparent film 6 was adhered to the rear substrate 1b.

A UV-curing acrylic resin 7 of a refractive index of 1.59 was coated on the transparent film 6, and a transparent substrate C was thereafter placed. The transparent substrate C and the transparent film 6 were sufficiently contacted to eliminate bubbles and an excessive transparent liquid. Then a UV irradiation was conducted (FIG. 3B), whereby the UV-curing acrylic resin was hardened to form a transparent solid.

Then the transparent substrate C was removed, and, after silicone oil was coated on the surface of the resin 7, a display substrate 1a of a material same as in the example 1 was placed thereon (FIG. 3C). No bubbles were left between the display substrate 1a and the resin 7 because of the above-mentioned silicone oil coating.

In thus prepared display apparatus, the UV-curing resin 7 could be formed into a lens shape in each pixel by a self-alignment effect. Besides, since the refractive index of the UV-curing resin 7 was smaller than that of the transparent film 6, the incident light could be concentrated in a central part of the pixel, thereby increasing the contrast. Also since the UV-curing resin 7 had elasticity, the substrates could be easily bent forward or backward, and no migration of the charged electrophoretic particles occurred by such bending. Also the drive status of the display apparatus was not at all affected when it was operated for a prolonged period under a high humidity condition (90%), and no intrusion of bubbles into the display pixels occurred.

### Example 3

In the present example, the transparent film 6 was constituted by a fluororesin film of a thickness of 8 μm and a refractive index of 1.35. Also for the transparent member 7, xylene with a refractive index of 1.52 was employed. Also the display substrate 1a was formed by PET of a thickness 100 μm in a central part and by PET of a thickness of 20 μm in a peripheral part. Other configurations and the producing method were same as those in the example 1.

The present example, as in the example 2, can concentrate the incident light in a central part of the pixel, thereby increasing the contrast. Also the substrates can be easily bent forward or backward, and no migration of the charged electrophoretic particles occurs by such bending. Also the drive status of the display apparatus is not at all affected when it is operated for a prolonged period under a high humidity condition (90%), and no intrusion of bubbles into the display pixels occurs.

### Effect of the Invention

In the embodiments of the present invention, in case the substrates are bent, a stress resulting from the difference in the circumferential length between the display substrate 1a and the rear substrate 1b is principally absorbed by a slippage between the display substrate 1a and the transparent film 6, and by a soft end portion B of the display substrate 1a. Also a stress resulting from a difference in the circumferential length of the transparent film 6 and the rear substrate 1b is absorbed by an elongation or a contraction of the transparent film. Therefore a stress on the partition member 2 in the shearing or compressing direction is made very small, and the substrates can be bent easily.

Also in case the transparent member is constituted by a liquid, there can be realized a very smooth slippage between the display substrate and the transparent film.

As the transparent film is very thin and in close contact with the partition members, it is not separated therefrom when the substrates are bent, even though it is not adhered, whereby the charged particles can be securely retained within the partition members.

Also since each pixel is shielded by a three-layered structure constituted by the display substrate, the transparent film and the transparent member, it is possible to prevent penetration of gas etc. from the exterior into each pixel.

Also by selecting the refractive index of the transparent member larger than that of the transparent film, there can be formed a self-aligned lens in each pixel, whereby the incident light can be concentrated in a central part of the pixel, thereby increasing the contrast.

What is claimed is:

1. An electrophoretic display apparatus comprising a display substrate and a rear substrate positioned with a predetermined gap between the substrates, partition members positioned between the substrates to partition a region between the substrates into pixels, a liquid and plural charged particles positioned in each pixel, and a first electrode and a second electrode provided in each pixel, and moving the charged particles by being applied a voltage between the electrodes to carry out a displaying:
wherein a transparent film thinner than the display substrate is positioned between the display substrate and the partition member, and a transparent member is positioned between the transparent film and the display substrate.

2. An electrophoretic display apparatus according to claim 1, wherein the liquid is transparent, the first electrode is arranged along the rear substrate, and the second electrode is arranged under the partition member.

3. An electrophoretic display apparatus according to claim 2, wherein the transparent member is provided in each pixel and has a convex shape protruding toward the liquid.

4. An electrophoretic display apparatus according to claim 3, wherein the transparent member has a refractive index larger than that of the transparent liquid.

5. An electrophoretic display apparatus according to claim 1, wherein the transparent film has a thickness smaller than a width of a pixel.

6. An electrophoretic display apparatus according to claim 1, wherein the transparent film has a thickness smaller than a height of the partition member.

7. An electrophoretic display apparatus according to claim 1, wherein the display substrate and the rear substrate are formed of a flexible material.
